(19) United States
(12) Patent Application Publication
(10) Pub. No.: US 2003/0161595 A1
(43) Pub. Date: Aug. 28, 2003

(54) Method of bonding optical devices

(76) Inventors: Joseph L. Dallas, Maple Glen, PA (US); Angelique X. Irvin, Radnor, PA (US); Robert W. Irvin, Radnor, PA (US); Ralph S. Jameson, Orefield, PA (US); William A. Mamakos, Laurel, MD (US)

Correspondence Address: CANTOR COLBURN, LLP, 55 GRIFFIN ROAD SOUTH, BLOOMFIELD, CT, 06002

(21) Appl. No.: 10/084,900

(22) Filed: Feb. 27, 2002

(51) Int. Cl. G02B 6/255

(52) U.S. Cl. 385/96

(57) ABSTRACT

A system and method are presented for fusion-splicing a first optical transmission member to a second optical transmission member with a heat source, the first and second optical transmission members each having a retaining member surface configured to form a continuous joint joining the first and second optical transmission members. The method includes disposing the first optical transmission member in a first retaining member and disposing the second optical transmission member in a second retaining member. First and second retaining members are composed of similar or like materials. Corresponding optical surfaces of the first and second optical transmission members are aligned along one axis. The heat source is directed to heat a specific region of the retaining member surfaces to be joined, adjusting a temperature level of the heat source to reach a temperature equal to or higher than the softening temperature of at least one of the retaining members surfaces to form a softening region thereon, placing the retaining member surfaces in proximity to one another, thereby achieving the fusion-splicing. Then allowing a joint formed intermediate one end defined by the first retaining member and another end defined by the second retaining member to cool.

### BACKGROUND

The present invention relates to optoelectronics involving optical components and, more particularly, to coupling optical components together, such as coupling optical fibers to optical elements such as waveguides, and the like.

Splicing of one optical fiber to another or of one optical fiber to an optical waveguide is known. Such splicing can be done by a variety of techniques, including fusion-splicing, which involves localized melting in the region of the splice. For example, U.S. Pat. No. 4,737,006 entitled “Optical Fiber Termination Including Pure Silica Lens And Method Of Making Same”, issued to K. J. Warbrick on Apr. 12, 1988, discloses fusion-splicing an undoped (pure) silica rod to a single mode fiber to fabricate a collimator, employing an electric arc. In another example, U.S. Pat. No. 6,217,698 entitled “Use of a Laser to Fusion-Splice Optical Components of Substantially Different Cross-Sectional Areas”, issued to Walters, et al. on Apr. 7, 2001, discloses fusion splicing of at least two optical components to a different optical component, the different optical component having a surface that has a comparatively larger cross-sectional area than a surface of the optical components.

The most often used processes for attaching optical fibers to the optical elements include (1) bonding the fiber faces directly to the optical element with adhesives or (2) engineering a complex mechanical housing which provides stable positioning of air-spaced fibers and optical elements throughout large changes in environmental conditions.

The use of adhesives in the optical path of such devices is undesirable due to the chance of degradation of the adhesive over time. On the other hand, spacing the fibers a fixed distance away from the optical elements by utilizing complex mechanical housings requires the use of anti-reflection coatings at all air-glass interfaces in order to minimize losses of optical energy through the device. The presence of air-glass interfaces also provides a source of back-reflected light into the optical fibers. This back-reflected light is a source of noise in many communication networks, and effectively limits transmission bandwidth of such communication networks.

In general, referring to FIG. 1, formation of a subassembly for optoelectronic devices includes a first retaining member or base 10 (e.g., silicon or silica glass) and a block cover 12 including a first optical transmission member that may include a variety of etched features, such as a waveguide 14 and metallization patterns (e.g., contacts, reflectors) which enable the optoelectronic device to be reliably and inexpensively mounted on the base 10 and coupled to a communicating optical fiber. Referring to FIG. 2, the standard process for attaching an optical fiber to a planar waveguide device 16, includes an arrangement wherein a block cover 12 is positioned to cover one end face 18 of a planar substrate base 10 having a waveguide 14. The end face 18 of the planar substrate/waveguide/cover 16 is ground and polished to form an optical surface. Next, a second optical transmission member such as a communicating optical fiber 20 disposed in a second retaining member such as a glass capillary tube 22 is aligned with the waveguide 14. An organic adhesive (not shown) is used to form a mechanical bond between the substrate/waveguide/cover and the capillary/fiber assemblies. Therefore, positioning of the communicating fiber with the waveguide is the only active alignment step required to provide coupling.

The coupled assembly is typically a module for use in fiberoptic communication systems that handle high speed optical data. However, using an organic adhesive layer between the waveguide assembly and the optical fiber assembly forms a bond that is subject to degradation from heat, humidity, optical power, and other outside external factors.

Accordingly, what is desired is a process for attaching one optical transmission device (e.g., an optical fiber) to another optical transmission device (e.g., a planar waveguide device) that is not subject to degradation from heat humidity, optical power, and the like. Furthermore, a method is desired for joining the assemblies without using an organic adhesive that raises concerns over deposition of organic molecules on the sensitive optical surfaces when the organic adhesive cures.

### BRIEF SUMMARY

In a first aspect of the present invention, there is provided a method for fusion-splicing a first optical transmission member to a second optical transmission member with a heat source, the first and second optical transmission members each having a retaining member surface configured to form a continuous joint joining the first and second optical transmission members, the method comprising: disposing the first optical transmission member in a first retaining member; disposing the second optical transmission member in a second retaining member, said first and second retaining members are composed of similar or like materials; aligning corresponding optical surfaces of the first and second optical transmission members along one axis; directing the heat source to heat a specific region of the retaining member surfaces to be joined; adjusting a temperature level of the heat source to reach a temperature equal to or higher than the softening temperature of at least one of the retaining members surfaces to form a softening region thereon; placing the retaining member surfaces in proximity to one another, thereby achieving the fusion-splicing; and allowing a joint formed intermediate one end defined by the first retaining member and another end defined by the second retaining member to cool.

In a second aspect of the invention, an optical device is disclosed comprising: a first optical transmission member within a first retaining member; and a second optical transmission member within a second retaining member, wherein the first and second optical transmission members are fusion-spliced using a heat source forming a continuous joint joining the first and second retaining members and optically joining optical surfaces of the first and second optical transmission members.

### BRIEF DESCRIPTION OF THE DRAWINGS

Referring to the exemplary drawings wherein like elements are numbered alike in the several Figures:

FIG. 1 is a perspective view of a waveguide substrate and cover for coupling with an optical element;

FIG. 2 is a side view of the waveguide substrate and cover of FIG. 1 aligned to be adhesively bonded to an optical fiber encapsulated in a glass capillary tube as in the prior art;

FIG. 3 is a side view of the waveguide substrate and cover aligned with the optical fiber encapsulated in the glass capillary tube of FIG. 2 to be fusion spliced in accordance with one embodiment of the present disclosure;

FIG. 4 is a side view of the fusion spliced waveguide substrate and cover to the optical fiber encapsulated in a glass capillary tube illustrated in FIG. 3;

FIG. 5a is a cross sectional perspective view of a substrate on a mounting block presented to an array of optical fibers in an optical fiber mounting block;

FIG. 5b is a plan view of an end face of the substrate on the mounting block shown in FIG. 5a; and

FIG. 5c is a plan view of the end face of an alternative embodiment illustrating multiple substrates on a mounting block.

### DETAILED DESCRIPTION OF THE PREFERRED EMBODIMENTS

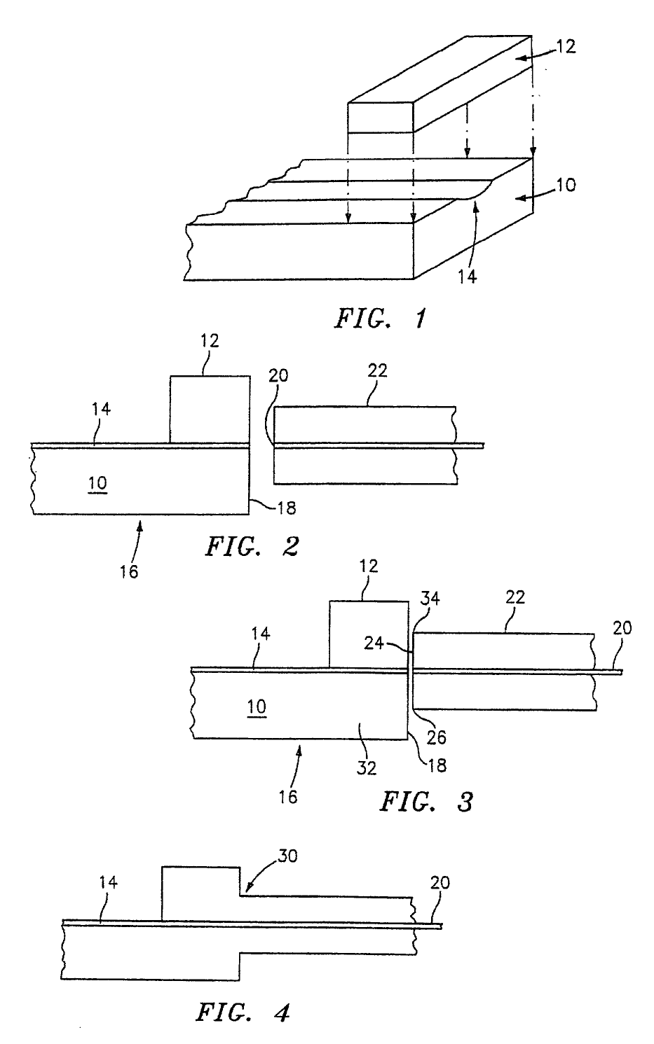

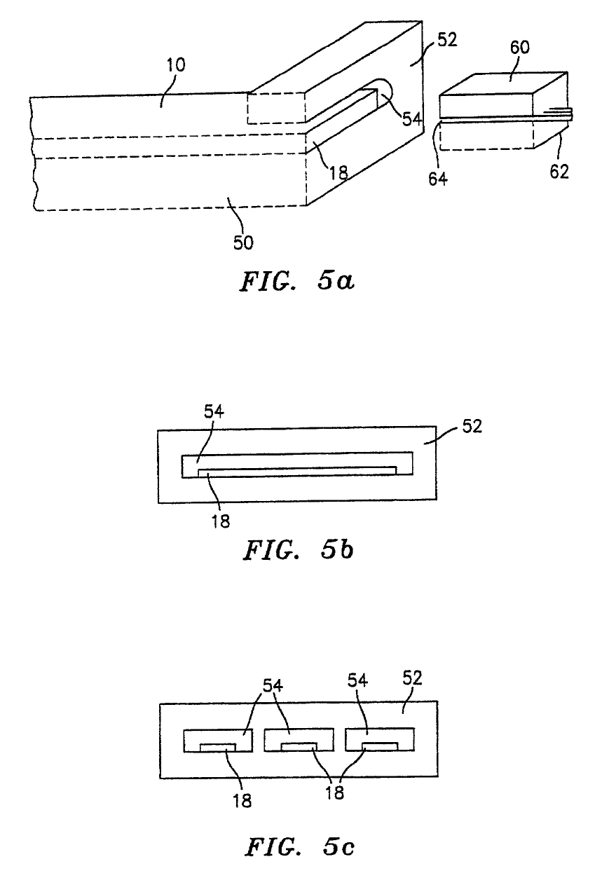

Some embodiments of the invention will now be described in detail in the following examples. FIG. 3 depicts the substrate/waveguide/cover 16 of FIG. 2 formed in a conventional manner known in the pertinent art. Although substrate/cover 16 are shown as a first retaining member encompassing a first optical transmission member (i.e., waveguide 14), it will be recognized that first retaining member may be a unitary substrate and that first optical transmission member may include a plurality of optical fibers, as well as any other optical device, as will be described later within. First retaining member and first optical transmission member are shown as substrate/cover 16 and waveguide 14 for contrast with the prior art. Likewise, optical fiber 20 represents a second optical transmission member that is disposed in glass capillary tube 22 representing a second retaining member. It will be recognized that second optical transmission member and corresponding second retaining member shown in FIG. 3 is not to be limited to the optical fiber 20 disposed within glass capillary tube 22. For example, second optical transmission member may include a fiber array mounted to a second retaining member, such as a unitary substrate, as illustrated in FIGS. 5a-c and described later herein. Furthermore, suitable materials for first and second retaining members may include, but are not limited to, metal, stainless steel, Fe—Ni—Co alloy (i.e., Kovar®), glass, organic polymer, plastic, and metallized ceramic.

Optical fiber 20 may be adhesively bonded to an inside bore defined by glass capillary tube 22. After bonding optical fiber 20 within glass capillary tube 22, optical fiber 20 is aligned with waveguide 14. End face 18 of substrate 10 and cover 12, and an end face 24 of capillary tube 22 having optical fiber 20, are optical surfaces prepared in the conventional manner before alignment with each other. The contacting regions 26 of the capillary tube 22, substrate 10, and cover 12 are heated in a specific region so that the glass surfaces in the contacting regions 26 melt to form a continuous joint 30, shown in FIG. 4. The contacting regions are allowed to cool to form a joint 30 that is solid and that mechanically, as well as optically, joins substrate 10 and cover 12 to capillary tube 22.

Localized heat has been effectively used in a variety of glass processing operations including surface polishing, fiber drawing, and fusion-splicing. The heat source used is frequently a simple resistance heater or a controlled arc. All of the aforementioned processes can also be performed using a laser as a heat source (e.g., a CO₂ laser).

To fuse optical components of substantially different cross-sectional areas (i.e., a difference in cross-sectional areas of at least two times), as in the above described embodiment, the larger surface of substrate 10 and cover 12 is optionally first preheated by the heat source (not shown, e.g., a laser). The pre-heat temperature is just sufficient to polish and melt the surface of end face 18 at the location one desires to fuse the glass capillary tube 22. Depending upon the size of the substrate and cover end face 18, it may be a heating of the entire surface of end face 18 or only a localized heating where end face 24 of capillary tube 22 will join end face 18. End face 24 is then brought into contact with the preheated surface of end face 18 and, once the thermal exchange is established (by conduction of heat), the two retaining surfaces are heated simultaneously. If both surfaces are large (large with respect to the localized heating zone), then both may need preheating. Once the surfaces are in contact at the appropriate elevated temperatures, fusion occurs. The fusion temperature is just enough above the softening temperature to ensure a good flow of thermal energy between the two retaining surfaces.

In a second embodiment, the fusion occurs starting with contact of the first and second optical transmission members and two optical transmission members are never separated during the fusion-splicing.

In a third embodiment, the first and second optical transmission members are brought into contact, then pulled back after alignment, and then fusion-spliced as in the first embodiment.

In a fourth embodiment, a periphery 34 of the second retaining member (e.g., capillary tube 22) is selectively heated such that the glass fusing takes place in a specific region around the circumference of capillary tube 22 (see FIG. 3). In this manner, glass fusing is absent in a region occupied by waveguide 14 and optical fiber 20. Thus, it may be desirable to apply an anti-reflection (AR) coating to an end face of optical fiber 20 and waveguide 14 prior to alignment and fusion.

In a fifth embodiment, illustrated in cross-sectioned perspective view in FIG. 5a, the first optical transmission member includes base 10 mounted upon a first retaining member 50 having an end face 52 containing an opening 54 through which the base 10 projects. Base 10 is bonded to first retaining member 50 through a means such as a solder or organic adhesive. It will be recognized by one skilled in the pertinent art that the adhesive includes, but is not limited to, metal solder, glass solder, organic adhesive, epoxy, and ultraviolet cure adhesive (UV-cure adhesive). In a preferred embodiment, the end face 18 of base 10 is aligned with the end face 52. One or more optical fibers 62 representing a second optical transmission member are mounted in and a second retaining member 60, with an optical surface of the optical fibers 62 preferably aligned with the end face 64 of second retaining member 60. First retaining member 50 and second retaining member 60 are made from a material (e.g. Kovar® ( Fe—Ni—Co alloy) or a stainless steel) which can be welded to a like or similar material. Other suitable materials include glass, organic polymer, plastic, and metallized ceramic. Second retaining member 60 is positioned relative to first retaining member 50 so that the optical fibers 62 are aligned with one or more optical waveguides 14 or one or more optical devices formed on base 10. The optical devices include, but are not limited to, at least one optical fiber, at least one optical waveguide, a planar waveguide structure, at least one optical emitting device, at least one optical detecting device, or at least one optical reflecting device, including combinations of the foregoing. The optical fibers are then fixed in position relative to the base 10 by welding the end face 64 of second retaining member 60 to end face 52 of first retaining member 50. It is preferred to provide a thin-film optical coating such as an anti-reflection coating (AR) on the end of the optical fibers 62 and on the end of the optical waveguides or devices formed on base 10, in order to reduce the amount of light lost to reflection at these surfaces.

As used herein, the term ‘weld’ refers to a process for joining two or more objects of like or similar material wherein regions of each object are selectively heated, said regions are placed in proximity to allow heated material from each object to contact and form as continuous material, and said regions are allowed to cool so that the entire material returns to a rigid state.

FIG. 5b shows a plan view of the end face 52, and the end face of the base 10. FIG. 5c shows a plan view of an alternative embodiment of an end face 52 of a first retaining member, in which multiple bases 10 project through multiple openings 54. Alternatively, multiple bases 10 may be mounted on the first retaining member 50 and project several end faces through a single opening 54. In each of the above embodiments, qualification of the interface formed is accomplished by measuring the optical loss through the system, the back reflection of light through the system, as well as mechanical testing of the formed joint.

Two optical transmission members or elements disposed in similar material can be fused using the method of the present disclosure. The most common application will be fusion of single mode fibers to optoelectronic or telecommunications devices. Fusion-splicing in accordance with the teachings herein virtually eliminates back-reflection and the associated losses. It is also very cost-effective, with a splice requiring a few seconds or less and the process can be fully automated. Splicing also ablates contaminants and precludes the need for foreign materials, such as adhesives and other organic materials, in the optical path.

Optical inorganic glasses, such as silicas, borosilicates, borates, phosphates, aluminates, chalcogenides and chalco-halides, halides, etc., and optical organic polymers, such as acrylates, methacrylates, vinyl acetates, acrylonitriles, styrenes, etc., may be beneficially employed in the practice of the present disclosure, although the present disclosure is not limited to the specific classes of materials listed.

Because the heating is quick and localized, components can be antireflection-coated on surfaces other than the surface to be fused prior to fusion. The process of the present disclosure also minimizes the number of coated surfaces. Typical assembly techniques leave a minimum of three surfaces to be coated: the fiber face and both the input and output faces of the lens. However, the process of the present disclosure leaves as few as one surface because two surfaces are combined into a monolithic fused piece. Every surface, even when coated, contributes losses to the system because there is no perfect antireflection coating. Thus, reducing the number of surfaces to be coated reduces losses to the system.

Pointing accuracy and beam quality can be monitored prior to fusion and locked in due to fusion. Because the part count and the labor intensity of the process are minimized, costs are very low.

Another distinct advantage of the embodiments described herein is the thermal stability of the system. Because the parts are seamlessly fused into a monolithic piece, there is no dependence on the housing for maintaining sub-micron spacing tolerances as there is with other prior art approaches in optoelectronic and telecommunications devices.

The present disclosure makes possible a very high quality and low cost product for the optoelectronics/telecommunications industry. Without this technology, one would be forced to use the prior art techniques known in the telecommunications industry, which are very costly, cannot perform as well, and/or use undesirable materials in the optical path.

The method of the present disclosure for splicing capillary tube 22 having optical fiber 20 to an optical waveguide component 16 comprises:

1. aligning the second optical transmission member disposed in the second retaining member and the first optical transmission member on the same axis;

2. directing the heat source to heat a specific region of the retaining member surfaces to be joined;

3. adjusting a temperature level of the heat source to reach a temperature equal to or higher than the softening temperature of at least one of the retaining member surfaces to form a softening region thereon, thereby achieving said fusion-splicing; and

4. allowing a joint formed intermediate one end defined by the first retaining member and another end defined by the second retaining member to cool.

In the first embodiment, the two components are aligned but separated by a space (typically a few millimeters), the heat source, preferably a laser beam is turned on to form the softening region, and the end face 24 of capillary tube 22 and optical fiber 20 are brought in contact with the softening region of the end face 18 of optical waveguide component 16 having the larger cross-sectional area, the contact resulting in heat transfer to the surface of end face 24 having the smaller cross-sectional area, which then softens, thereby achieving the fusion-splicing.

In the second embodiment, the two components are first brought into contact and the heat source, preferably a laser beam, is then turned on to form the softening region where the two components are in contact to achieve the fusion-splicing.

In the third embodiment, the two components are aligned, then brought into contact, then separated by a space (typically a few millimeters), the heat source, preferably a laser beam, is turned on to form the softening region, and the surface of end face 24 having the smaller cross-sectional area is brought in contact with the softening region of the optical waveguide component 16 having the larger cross-sectional area, the contact resulting in heat transfer to the surface of end face 24 having the smaller cross-sectional area, which then softens, thereby achieving the fusion-splicing.

In the fourth embodiment, the two components are aligned, then brought into contact, then separated by a space (typically a few millimeters), the heat source, preferably a laser beam, is turned on to form the softening region on periphery 34 of second retaining member, for example, capillary tube 22, such that the glass fusing takes place in a specific region around the circumference of capillary tube 22 (see FIG. 3) when the two components are brought together. In this manner, glass fusing is absent in a region occupied by waveguide 14 and optical fiber 20. Thus, it may be desirable to apply an anti-reflection (AR) coating to an end face of optical fiber 20 and waveguide 14 prior to alignment and fusion.

In the fifth embodiment, the above methods described are employed in joining a plurality of first optical transmission members to corresponding second optical transmission members (e.g., a fiber optic array to corresponding waveguides), thereby eliminating the need for a bonding adhesive subject to degradation.

For fusion-splicing typical inorganic glasses, such as silica, a CO₂ laser, which operates in the range 9 to 11 μm, is preferred, since silica-based glasses have very large absorption coefficient. Other optical materials typically have a large absorption in the infrared, and accordingly, lasers operating in another region of the IR spectrum may be used with such other optical materials.

The two optical components being fusion-spliced preferably have similar thermal and/or mechanical properties. However, this is not a necessary requirement, since dissimilar optical components can be fusion-spliced employing the teachings of the present disclosure. In such cases, the possibility of strain due to the process may cause the splice to break if the conditions are not right, and thus must be taken into account. However, such a consideration is well within the experience of the person skilled in this art, and no undue experimentation is required.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method for fusion-splicing a first optical transmission member to a second optical transmission member with a heat source, the first and second optical transmission members each having a retaining member surface configured to form a continuous joint joining the first and second optical transmission members, the method comprising:
disposing the first optical transmission member in a first retaining member;
disposing the second optical transmission member in a second retaining member, the first and second retaining members are composed of similar or like materials;
aligning corresponding optical surfaces of the first and second optical transmission members along one axis;
directing the heat source to heat a specific region of the retaining member surfaces to be joined;
adjusting a temperature level of the heat source to reach a temperature equal to or higher than the softening temperature of at least one of the retaining members surfaces to form a softening region thereon;
placing the retaining member surfaces in proximity to one another, thereby achieving the fusion-splicing; and
allowing a joint formed intermediate one end defined by the first retaining member and another end defined by the second retaining member to cool.

2. The method of claim 1 wherein the heat source includes one of an electric arc and a laser.

3. The method of claim 2 wherein the laser operates in a wavelength region of about 9 to about 11 μm.

4. The method of claim 3 wherein the laser is a CO₂ laser.

5. The method of claim 1 wherein the retaining member surfaces comprise silica-based glasses.

6. The method of claim 1 wherein the one end of the first retaining member is ground and polished.

7. The method of claim 1 wherein the second retaining member includes a glass capillary tube and the second optical transmission member includes an optical fiber, the optical fiber being disposed in the glass capillary tube, the tube is heated at the another end on a periphery of the tube to form the softening region and the joint.

8. The method of claim 7 wherein an anti-reflection coating is applied to end face portions of the optical fiber and the first optical transmission member to be joined prior to the aligning and fusion.

9. The method of claim 7 wherein the directing of the heat source includes heating the optical fiber and the glass capillary tube, through which the optical fiber passes, at the another end.

10. The method of claim 9 wherein the optical fiber forms the joint with respect to the first optical transmission member and corresponding retaining member surfaces associated with each.

11. The method of claim 7 further comprising:
bonding the optical fiber in the glass capillary tube with an adhesive.

12. The method of claim 1 wherein the first and second optical transmission members with corresponding retaining member surfaces are aligned but separated by a space, the heat source is directed to form the softening region, and the surface of the first and second optical transmission members at the another end is brought in contact with the softening region of the first retaining member, the contact resulting in heat transfer to the second optical transmission member and second retaining member, which then soften, thereby achieving the fusion-splicing.

13. The method of claim 1 wherein the first and second optical transmission members with corresponding retaining member surfaces are first brought into contact and the heat source is directed to form the softening region where the first and second optical transmission members with corresponding retaining member surfaces are in contact to achieve the fusion-splicing.

14. The method of claim 1 wherein the first and second optical transmission members with corresponding retaining member surfaces are aligned, then brought into contact, then separated by a space, the heat source is directed to form the softening region, and the surface of the second optical transmission member and the second retaining member at the another end is brought in contact with the softening region of the first retaining member, the contact resulting in heat transfer to the second optical transmission member and second retaining member, which then softens, thereby achieving the fusion-splicing.

15. The method of claim 1 wherein both the first and second retaining members have similar thermal and mechanical properties.

16. The method of claim 1 wherein the second optical transmission member includes a plurality of optical fibers forming a fiber optic array and the first optical transmission member includes a plurality of optical waveguides corresponding to the plurality of optical fibers.

17. The method of claim 1 wherein at least one of the first and second retaining members is a unitary substrate.

18. The method of claim 1 further comprising:
covering the first optical transmission member with a cover.

19. The method of claim 1 wherein at least one of the first and second optical transmission members includes one of the following:
at least one optical fiber,
at least one optical waveguide,
a planar waveguide structure,
at least one optical emitting device,
at least one optical detecting device, and
at least one optical reflecting device.

20. The method of claim 1 wherein the first and second retaining members comprise at least one of, including combinations of at least one of the following materials:
metal,
stainless steel,
Fe—Ni—Co alloy,
glass,
organic polymer,
plastic, and
metallized ceramic.

21. The method of claim 1 wherein the first and second optical transmission members depend from corresponding first and second retaining members by at least one of, including combinations of at least one of the following:
metal solder,
glass solder,
organic adhesive,
epoxy, and
ultra-violet cure adhesive (UV-cure adhesive).

22. The method of claim 1 wherein at least one of the optical surfaces of the first and second optical transmission members has a thin film optical coating deposited thereon.

23. An optical device comprising:
a first optical transmission member within a first retaining member; and
a second optical transmission member within a second retaining member, wherein the first and second retaining members are fusion-spliced using a heat source forming a continuous joint joining the first and second retaining members and optically joining optical surfaces of the first and second optical transmission members.

24. The optical device of claim 23 wherein the first and second retaining members are composed of similar or like materials.

25. The optical device of claim 23 wherein at least one of the first and second optical transmission members includes one of the following:
at least one optical fiber,
at least one of optical waveguide,
a planar waveguide structure,
at least one optical emitting device,
at least one optical detecting device, and
at least one optical reflecting device.

26. The optical device of claim 23 wherein the first and second retaining members comprise at least one of, including combinations of at least one of the following materials:
metal,
stainless steel,
Fe—Ni—Co alloy,
glass,
organic polymer,
plastic, and
metallized ceramic.

27. The optical device of claim 23 wherein the first and second optical transmission members depend from corresponding first and second retaining members by at least one of, including combinations of at least one of the following:
metal solder,
glass solder,
organic adhesive,
epoxy, and
ultra-violet cure adhesive (UV-cure adhesive).

28. The method of claim 23 wherein at least one of the optical surfaces of the first and second optical transmission members has a thin film optical coating deposited thereon.
